(19) United States
(12) Patent Application Publication
(10) Pub. No.: US 2018/0214999 A1
(43) Pub. Date: Aug. 2, 2018

(54) SPINDLE UNIT FOR A MACHINE TOOL FOR FINE-MACHINING WORKPIECES THAT HAVE GROOVED-SHAPED PROFILES

(71) Applicant: REISHAUER AG, Wallisellen (CH)

(72) Inventors: Ronald JAKOB, Russikon (CH); Theophil HUG, Wallenwil (CH); Erwin SENNHAUSER, Kleinandelfingen (CH)

(73) Assignee: REISHAUER AG, Wallisellen (CH)

(21) Appl. No.: 15/579,649

(22) PCT Filed: Jun. 2, 2016
(86) PCT No.: PCT/EP2016/062487

§ 371 Date: Dec. 5, 2017

(30) Foreign Application Priority Data
Jun. 15, 2015 (CH) 00851/15

(51) Int. Cl. B23Q 1/70; B23Q 1/38; B24B 41/04; F16C 17/26; F16C 32/06; F16C 35/10

(52) U.S. Cl. CPC B23Q 1/70; B23Q 1/385; B24B 41/04; F16C 35/10; F16C 32/0644; F16C 32/0696; F16C 17/26

(57) ABSTRACT

A spindle unit for a machine tool for fine-machining workpieces having groove-shaped profiles, has a rotatably mounted spindle shaft (2). The spindle shaft is subdivided in the axial direction (AR), one behind the other, into a fastening portion (A) for fastening a tool (4) or a workpiece to be machined, a first bearing portion (B), a force transmission portion (C), and a second bearing portion (D). A drive unit (5) serves to drive the spindle shaft by way of force transmission onto the force transmission portion. A first and a second bearing point (13, 14) are designed to bear the spindle shaft in the first bearing portion, and a third bearing point (15) serves to mount the spindle shaft on the second bearing portion. The first and the second bearing points each have one or more hydrostatic bearings. The third bearing point has one or more hydrostatic and/or hydrodynamic bearings.

### TECHNICAL FIELD

The invention relates to a spindle unit for a machine tool for fine-machining workpieces having groove-shaped profiles, in particular such as teeth, having a rotatably mounted spindle shaft which may be driven in a rotational movement by means of a drive unit for machining workpieces.

### PRIOR ART

When fine-machining workpieces having groove-shaped profiles, and in particular when grinding gears, ever preciser surfaces are desired. The quality of these workpieces is determined in particular by the dimensional accuracy, roughness, shape accuracy and corrugation of the surfaces of the groove-shaped profile. These desired surface qualities are achieved for example by the use of machine tools for milling, honing, shaving, profile grinding and roller grinding.

Depending on the type of fine-machining machine tool, this has at least one spindle unit, which has at least one spindle shaft in the form of a tool- or workpiece spindle which is rotatably mounted. A tool spindle, to which a tool, in particular such as a profile grinding wheel and/or a worm grinding wheel, is attached, is used for example in profile grinding machines or gear grinding machines. A tool spindle can also be a truing spindle, which serves for mounting a truing tool. On workpiece spindles, it is not the tool, but the workpiece to be machined which is mounted.

For the fine-machining process, the spindle shaft, and therefore the tool or workpiece attached thereto, is set in rotation by means of a drive unit. A peculiarity of the fine-machining process for groove-shaped profiles, in particular gears, is that the machining takes place predominantly at the groove or tooth flank, wherein asymmetric and/or alternating forces can occur. These workpieces are generally also hardened. In addition to a high radial rigidity, these spindles therefore also have to have a higher than average axial rigidity.

In addition to the rigidity and the damping of the mechanical parts, the highly precise drive, a particularly decisive factor when enabling high surface qualities to be achieved with such machine tools is the bearing of the spindle shaft. Even the smallest vibration of the spindle shaft is transferred to the tool attached thereto and therefore to the surfaces of the workpiece to be machined. The same also applies to workpiece spindles, whereof the vibrations are transferred directly to the workpiece attached thereto and are visible and measurable thereon.

So that it is possible to achieve today's extreme requirements in terms of the surface qualities of workpieces, and in particular gears, the spindle shafts of fine-machining machine tools are mounted in pre-tensioned spindle bearings of the highest possible quality. A plurality of machine tools, and in particular gear grinding machines, having differently configured spindle bearings is known.

For example, DE 10 2009 039 752 A1 discloses a solution in which a grinding tool is supported and driven on both sides along its axis of rotation.

In the tool head described in EP 1 803 518 A2, high-precision, single-row, play-free and pre-tensioned spindle bearings are used, which are integrated as a bearing set with a greater bearing spacing and in an O-arrangement. A displaceable counter-bearing, which is designed to be substantially symmetrical to the first bearing set, is furthermore provided for the tool to be mounted on two sides. A further spindle bearing is additionally arranged at the first spindle end, which can mainly absorb radial forces, but also axial forces. DE 295 07 871 U1 describes a similar bearing using anti-friction bearings in a bobbing machine.

DE 10 2012 018 358 A1 discloses a spindle shaft of roller- and profile grinding machines, which comprises a bearing point which is arranged along the axis of rotation in the region of the bore of a grinding tool when such a grinding tool is attached to the spindle shaft.

The rotational speed of the spindle shaft is an important factor for the productivity, the excitation behavior (vibrations), the cutting forces and further parameters, and it would therefore also be interesting to carry out machining at higher circumferential speeds, although the spindle bearings often do not permit this. On the other hand, if the tool diameter (e.g. of the grinding wheel) or the workpiece diameter, respectively, is selected to be larger, the circumferential speed increases; however, the load on the bearings then also increases. It is thus necessary to use larger spindle bearings, although these again only permit a lower rotational speed. This therefore means that, in conventional fine-machining machine tools, there is an inevitable optimum balance between rotational speed and load on the spindle bearings (for the space available).

EP 0 860 232 B1 discloses a high-speed spindle for milling or drilling operations, which is supported on both sides along its axis of rotation with respect to the drive motor by means of hydrostatic bearings and has special seals for the high-speed region. The two conical bearing seats are realized in the known X arrangement so that the bearing gap becomes smaller upon an increase in temperature. However, this arrangement is disadvantageous for absorbing tilting moments. Since the two bearing points are situated far apart due to the drive unit situated between them, the influence of the thermal expansion on the bearing points is additionally disadvantageous. A hydrostatic bearing of a spindle shaft is also proposed in DE 36 41 621 A1.

Further spindle units for camshaft grinding machines, general grinding machines and lathes having at least partly hydrostatic bearings are disclosed in DE 196 35 687 A1, EP 0 779 127 A1 and DE 42 34 049 A1.

EP 0 840 190 B1 moreover discloses a special pressure controller (progressive flow controller) for a hydrostatic bearing, which is based on exclusively mechanical or hydraulic components, respectively, and has a compact construction.

### REPRESENTATION OF THE INVENTION

It is therefore an object of the present invention to provide a spindle unit for a machine tool for fine-machining groove-shaped profiles, in particular such as teeth, which can be operated at high rotational speeds and in which vibrations are at the same time optimally damped. In addition to a high radial rigidity, the spindle unit here should also have as high an axial rigidity as possible. To achieve this object, a spindle unit as described in claim 1 is proposed. A machine tool having such a spindle unit is moreover described in claim 17. Advantageous embodiments of the invention are described in the dependent claims.

The present invention therefore describes a spindle unit for a machine tool for fine-machining workpieces having groove-shaped profiles, in particular such as teeth. The spindle unit has
a spindle shaft which is mounted to be rotatable about an axis of rotation and defines an axial direction and a radial direction with this axis of rotation, and which is divided successively in the axial direction into a mounting portion for attaching a tool or a workpiece to be machined, a first bearing portion, a force-transfer portion and a second bearing portion,
a drive unit for driving the spindle shaft in a rotational movement about the axis of rotation by means of force transfer to the force-transfer portion,
a first bearing point and a second bearing point for supporting the spindle shaft in the first bearing portion, and
a third bearing point for supporting the spindle shaft in the second bearing portion.

The first and the second bearing point each have one or more hydrostatic bearings and are each formed for absorbing both radial and axial forces. The third bearing point has one or more hydrostatic and/or hydrodynamic bearings and is formed for absorbing radial forces.

As a result of the first and the second bearing point each having a hydrostatic bearing and both being arranged on the first bearing portion which adjoins, or even overlaps, the mounting portion, vibrations produced during operation of the machine tool are damped close to the tool or workpiece, respectively.

Relative to the longitudinal extent of the spindle shaft, the two bearing points are advantageously as close as possible to the tool or the workpiece to be machined, respectively, i.e. in particular in the immediate vicinity thereof, whereby possible vibrations only have a minimal effect on the movement of the tool or workpiece, respectively. As a result of the additional radial bearing of the spindle shaft in the second bearing portion, vibrations produced in this portion are not able to amplify and thereby impair the movement of the grinding tool or the workpiece, respectively. In this regard, please refer in particular to the bending lines illustrated in FIGS. 2 and 3 and the embodiments relating to these two figures further below.

With the relatively high axial forces and tilting moments typical of the method, the hydrostatic design of the bearing of the first and second bearing point as well as the hydrostatic and/or hydrodynamic design of the bearing of the third bearing point enable relatively high rotational speeds of the spindle shaft of 3000 or even more revolutions per minute, at the same time with optimal damping. The first and the second bearing point advantageously have exclusively hydrostatic bearings and the third bearing point has exclusively hydrostatic and/or hydrodynamic bearings. This spindle unit therefore enables a very quick and extremely precise fine-machining of the groove-shaped profiles of a workpiece. Hydrostatic bearings are generally practically without wear under normal operating conditions so that, in comparison with anti-friction bearings, for example, regular bearing maintenance is unnecessary. Hydrostatic bearings furthermore exhibit substantially easier and more efficient bearing cooling than anti-friction bearings. A particular advantage is that their properties remain substantially unaltered over a large rotational speed range. All in all, the technical effects of hydrostatic or hydrodynamic lubrication, respectively, known to the person skilled in the art, can be used very effectively in this spindle unit.

The machine tool for fine-machining can be for example a milling machine, profile grinding machine, gear grinding machine or further fine-machining machine tools for gears. The spindle unit can be a tool spindle or a workpiece spindle. In the case of a tool spindle (for machining a workpiece, for example a gear) this can also be a truing spindle (for truing a tool). The workpiece to be machined which has a groove-shaped profile or groove-shaped profiles can be for example a gear. The machine tool generally has at least two spindle shafts rotating at high speed, which are each arranged in a fixed housing and are rotatably mounted by means of the first, second and third bearing point.

The axis of rotation normally corresponds to the longitudinal center axis of the spindle shaft and extends in the axial direction. The radial direction, or a host of radial directions, respectively, extends outwards from the axis of rotation at a right angle to the axial direction. The spindle shaft is generally substantially rotationally symmetrically formed, with the longitudinal center axis as the axis of symmetry. It would be advantageous to form the spindle shaft in one piece as a whole, although this is not always possible due to production- and assembly-related reasons.

The successive division of the spindle shaft along its axis of rotation into a mounting portion, a first bearing portion, a force-transfer portion and a second bearing portion means that, in the axial direction, the first bearing portion is arranged between the mounting portion and the force-transfer portion and the force-transfer portion is located between the first and the second bearing portion. The mounting portion, the first bearing portion, the force-transfer portion and the second bearing portion advantageously adjoin one another directly along the axis of rotation here, i.e. there are no additional intermediate portions.

The first bearing portion and the mounting portion, to which a mounting device for attaching a tool or a workpiece to be machined is normally attached, can mutually overlap in the axial direction. In the axial direction, the first bearing point can therefore be arranged in the region of the mounting device attached to the mounting portion and can therefore be located at substantially the same height as the mounting device relative to the axis of rotation. It is essentially also conceivable that the first bearing portion and the force-transfer portion and/or the force-transfer portion and the second bearing portion overlap one another. However, the first bearing portion, the force-transfer portion and the second bearing portion can also adjoin one another in each case without overlapping one another.

The spindle shaft generally has two ends which are normally formed by the mounting portion and the second bearing portion. The mounting device is advantageously arranged on the free end formed by the mounting portion.

The spindle unit preferably has a housing in which the spindle shaft is arranged. The housing is generally fixed so that the spindle shaft can rotate relative thereto about the axis of rotation.

The drive unit is preferably an electric motor having a stator unit, which is fixedly connected to the housing, and having a rotor unit, which is attached to the force-transfer portion of the spindle shaft in a torsion-resistant manner.

The first and the second bearing point are arranged in a variety of positions of the spindle shaft in the axial direction and, thereby, are generally arranged with their bearings and in particular bearing pockets at a spacing from one another in the axial direction. The bearing pockets belonging to the same bearing are preferably arranged at the same point in each case, relative to the axial direction, and, if possible, distributed at regular spacings about the axis of rotation. The bearings of the first and second bearing point can be designed with the same or different diameters.

The mounting device can be a flange, a cone receiving means or any mounting option. The mounting device preferably serves for attaching a particularly substantially hollow-cylindrical grinding tool. The grinding tool can be for example a worm grinding wheel or a profile grinding wheel. However, the mounting device can also serve for attaching a workpiece to be machined or a truing tool.

Preferably the first or the second bearing point, and more preferably both the first and the second bearing point, is conically formed. By means of a conical form of the first and/or the second bearing, it is possible to achieve both an axial and a radial bearing of the spindle shaft, wherein the same bearing pockets then absorb both axial and radial forces. Alternatively, the first and/or the second bearing point can also each have at least one planar axial and/or at least one cylindrical radial bearing, which together absorb the axial and also the radial forces.

If both the first and the second bearing point are conically formed, the cones formed by these two bearing points are advantageously aligned in mutually opposite directions in relation to the axis of rotation. Tilting moments, but also axial forces, can thus be very advantageously absorbed both in the direction of the axis of rotation and also in the opposite direction thereto. The cones of the first and second bearing advantageously each taper towards one another. A bearing arrangement of this type having cones tapering towards one another in each case is known to the person skilled in the art as a so-called O-arrangement. An X-arrangement of the first and the second bearing would essentially also be conceivable. However, an O-arrangement is advantageous due to its greater tilting rigidity.

The cones formed by the first and/or by the second bearing point preferably have an opening angle in a range of 10° to 60° in relation to the axis of rotation. It has been shown that, with such an opening angle, radial and axial forces can be optimally absorbed so that undesired vibrations of the grinding tool or the workpiece can be minimized.

The hydrostatic and/or hydrodynamic bearing of the third bearing point can be in particular a radial bearing. However, the bearing of the third bearing point can also serve to absorb force components acting both in the axial direction and the radial direction. In this case, the third bearing point can have in particular a conically formed bearing which can advantageously absorb tensile forces acting on the spindle shaft in the axial direction. Alternatively or additionally to a radial bearing, the third bearing point can have an axial bearing which can be in particular a hydrostatic bearing. The third bearing point can therefore also be an axial bearing or an axial radial bearing. As the force components acting in the axial direction can also be absorbed by the third bearing point in the second bearing portion, the system can be additionally damped and/or reinforced.

As a general rule, the first bearing point has one or more first bearing pockets and the second bearing point has one or more second bearing pockets. Preferably at least one first pressure controller is provided for controlling the pressure conditions prevailing in the first bearing pockets and at least one second pressure controller is moreover provided, which serves for controlling the pressure conditions prevailing in the second bearing pockets. The second pressure controller(s) here is/are advantageously formed separately in relation to the first pressure controller(s), which means that the pressure conditions prevailing in the corresponding bearing pockets can be controlled independently of one another. As mutually separately formed pressure controllers are provided in each case for the two bearings, these can, on the whole, be accommodated in a simpler and more space-saving manner. The bearing pressures can moreover be set independently of one another, wherein it is necessary to maintain the force equilibrium in the bearing system without an operating load.

The first and second pressure controller(s) is/are advantageously each arranged in the region of the first bearing portion and, where present, the third pressure controller(s) is/are arranged in the region of the second bearing portion. The first pressure controller(s), the second pressure controller(s) and preferably also the third pressure controller(s) are each particularly advantageously arranged at the same height as the first, the second and the third bearing point relative to the axial direction. The first, second and third pressure controllers here can each be accommodated in particular in one or more fixed sleeves, which serve in particular for supporting the spindle shaft and are attached to a housing in a torsion-resistant manner.

If a plurality of first bearing pockets and a plurality of second bearing pockets as well as a plurality of first pressure controllers and a plurality of second pressure controllers are present, one of the first pressure controllers is preferably associated with each of the first bearing pockets in each case and one of the second pressure controllers is associated with each of the second bearing pockets in each case. Therefore, there is preferably the same number of first pressure controllers as first bearing pockets and the same number of second pressure controllers as second bearing pockets. The pressure conditions of the individual bearing pockets can thus be controlled individually.

The third bearing point advantageously has a hydrostatic bearing having one or more third bearing pockets which are preferably each arranged at the same height relative to the axial direction and, if possible, distributed at regular spacings about the axis of rotation. At least one third pressure controller is then preferably provided, which serves to control the pressure conditions prevailing in the third bearing pockets and is formed separately in relation to the first pressure controller(s) and the second pressure controller(s). If a plurality of third bearing pockets and a plurality of third pressure controllers are present, one of the third pressure controllers is advantageously associated with each of the third bearing pockets in each case. The third bearing point is thus afforded the advantages mentioned in the two previous sections relating to the first and second bearing point.

The dissipation of heat from the first and the second, preferably also the third, bearing point is advantageously effected by a fluid provided in the bearing pockets of the hydrostatic bearing, which fluid circulates to this end in an advantageously common fluid circuit through the bearing pockets of the first, second and preferably also the third bearing point and through a cooling device. This extremely effective cooling furthermore ensures bearing properties which are virtually independent of the rotational speed. The fluid circuit can, at the same time, also serve for lubricating the respective bearing points.

The fluid circuit preferably moreover serves for cooling the drive unit. It is thus possible to achieve extremely simple and efficient lubrication and cooling of the different bearing points and the drive unit with the same fluid circulating in the fluid circuit. The cooling of this fluid can be effected by means of a single cooling device arranged in the circuit. A common fluid reservoir is preferably present, which is formed for receiving the fluid used for lubricating and/or cooling the bearing points and for cooling the drive unit. The different bearing points are arranged preferably parallel to one another in the fluid circuit. However, a series connection of the bearing points in the fluid circuit would also be conceivable. The drive unit is likewise arranged preferably parallel to the bearing points in the fluid circuit, wherein a series connection would essentially also be conceivable here.

The first pressure controller(s), the second pressure controller(s) and preferably also the third pressure controller(s) each advantageously have a compact construction. The pressure controllers can in particular each be accommodated in compact housings, which are substantially closed to the outside and are connected to the bearing pocket(s) of the respective bearing point via a pressure line.

According to a further development of the invention, the first pressure controller(s), the second pressure controller(s) and preferably also the third pressure controller(s) are each based exclusively on mechanical and/or hydraulic elements. This dispenses with the need for a complex electronic pressure control system with corresponding wiring. The first, the second and, where present, advantageously also the third pressure controllers are preferably formed as so-called PM flow controllers (progressive flow controllers) as disclosed in EP 0 840 190 B1, the content of which is incorporated herein in its entirety through reference in the present description. A PM flow controller refers to a controller which is formed according to one of claims 1, 4, 10, 11 and 14 of EP 0 840 190 B1. If this compact PM flow controller disclosed in EP 0 840 190 B1 is used in spindle units having a hydrostatic spindle bearing, disruptive vibrations are virtually preventable and the relatively simple miniaturizable construction enables the arrangement directly on the respective spindle. This PM flow controller furthermore operates with a relatively low power loss as a result of the possible use of low-viscosity oils or water or emulsions, whilst at the same time ensuring a higher bearing rigidity compared to alternative controller systems.

However, the pressure control in the first, second and/or third pressure controllers can, for example, alternatively take place by means of capillaries and/or throttles and/or restrictors and/or by means of an electronic control or further control systems of hydrostatic bearings corresponding to the prior art. Hydrodynamic bearing principles from the prior art can moreover also be used.

A mounting device for attaching a tool or a workpiece to be machined is generally attached to the mounting portion of the spindle shaft. The first and the second bearing point can each be arranged between the mounting device and the force-transfer portion in the axial direction. As the first and the second bearing point are arranged at a spacing from the mounting device in the axial direction, and in particular outside the region in which the grinding tool or workpiece, respectively, comes to lie along the axis of rotation, the spindle diameter measured in the radial direction can be minimal in the region of the mounting device. This enables the attachment of grinding tools or workpieces having very small bore or internal diameters, respectively. Grinding tools or workpieces having small bore diameters, respectively, are then used for example when, in view of the high rotational speeds in the radial direction, a certain wall thickness is required, with the external diameter at the same time being limited.

The first bearing point can be arranged at substantially the same height, or at least in part at the same height, as the mounting device in the axial direction, but also in the region of the mounting device, i.e. along the axis of rotation. The first bearing portion and the mounting portion then overlap one another in the axial direction. The bending rigidity of the spindle shaft can thus be positively influenced; possible undesired vibrations are damped directly at the grinding tool or workpiece, respectively, and the overall length of the spindle shaft can be minimized.

In particular, if the first bearing portion and the mounting portion overlap one another in the axial direction, the first pressure controller(s) is/are preferably arranged in the region of the mounting device along the axial direction and particularly preferably within the mounting device in the radial direction.

The spindle unit advantageously additionally has an angle measuring device arranged on the spindle shaft. This angle measuring device preferably has one or more of the following functions:
actual rotational-speed value transmitter for rotational speed control;
position transmitter for position control;
electrical commutation, for example of a synchronous motor.

The rotational movement of the grinding tool or workpiece attached to the spindle shaft can thus be optimally synchronized to that of the workpiece or grinding tool, respectively. Precise synchronization of the two rotational movements of the grinding tool and workpiece is necessary to enable a high grinding quality to be achieved. One or more angle measuring devices can be provided. To ensure as precise a measurement as possible, the angle measuring device is advantageously arranged on the mounting portion or directly adjacent to the mounting portion. However, an angle measuring device can alternatively or additionally also be arranged on the second bearing portion. An arrangement of the angle measuring device on the second bearing portion is therefore an option because the space conditions for the angle measuring device are often more favorable there and because the second bearing portion is normally more easily accessible, so that the angle measuring device can be assembled more easily on, or removed from, respectively, the machine tool during assembly and/or for maintenance. As a result of the radial stabilization of the spindle shaft at the third bearing point, measuring errors registered by the angle measuring device owing to a bending of the spindle shaft are considerably reduced. This is a further and essential advantage of this bearing arrangement. If the third bearing point is formed in such a way that, in addition to radial forces, axial forces acting as tensile forces on the spindle shaft are also absorbed, it is then possible to achieve an even more effective stabilization of the spindle shaft.

It has been shown that optimum sealing of the bearing pockets of the first and the second bearing point, preferably also the third bearing point, can be achieved if sealing-air arrangements are provided in each case for this purpose. The sealing-air arrangements seal the bearing pockets of the first, second and preferably also the third bearing point advantageously to the outside on both sides, in each case in the axial direction.

### BRIEF DESCRIPTION OF THE DRAWINGS

Preferred embodiments of the invention are described below with reference to the drawings, which merely serve for explanation and are not to be interpreted as restrictive. The drawings show:

FIG. 1 a perspective view of an inventive spindle unit of a machine tool according to a first inventive embodiment;

FIG. 2 a central sectional view of a non-inventive spindle unit of a machine tool having a spindle shaft, which is radially mounted only in the first bearing portion (B), but not in the second bearing portion (D), to illustrate a possible characteristic bending behavior of the spindle shaft;

FIG. 3 a central sectional view of the spindle unit of FIG. 1 having a spindle shaft which is radially mounted both in the first bearing portion (B) and in the second bearing portion (D) to illustrate a possible bending behavior of the spindle shaft;

FIG. 4a a central sectional view through the spindle unit of FIG. 1;

FIG. 4b a perspective view of the spindle unit of FIG. 1, cut away centrally along its axis of rotation, without a spindle shaft;

FIG. 4c a sectional view through the plane I-I indicated in FIG. 4a;

FIG. 4d a sectional view through the plane II-II indicated in FIG. 4a;

FIG. 4e a sectional view through the plane III-III indicated in FIG. 4a;

FIG. 5 a central sectional view through a spindle unit of a machine tool according to a second inventive embodiment;

FIG. 6 a central sectional view through a spindle unit of a machine tool according to a third inventive embodiment;

FIG. 7 a central sectional view through a spindle unit of a machine tool according to a fourth inventive embodiment;

FIG. 8 the diagram of an exemplary fluid circuit for lubricating the bearing points of an inventive spindle unit of a machine tool; and

FIG. 9 a detailed view of the diagram of FIG. 8 in the region of the spindle shaft.

### DESCRIPTION OF PREFERRED EMBODIMENTS

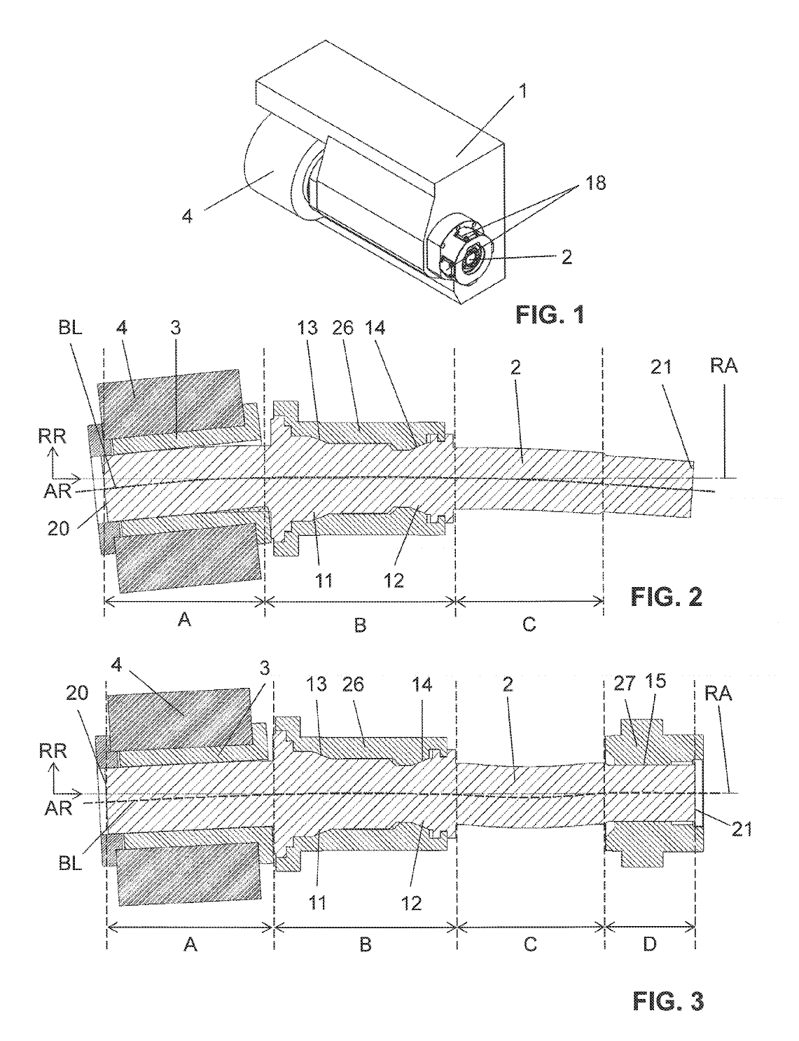

FIGS. 1 to 7 show different embodiments of the spindle units of machine tools for fine-machining workpieces having groove-shaped profiles. Similar-acting elements are each denoted by the same reference signs in the different embodiments.

The spindle units shown in FIGS. 1 to 7 each have a spindle shaft 2 with a grinding tool 4 attached thereto. The spindle shafts shown in FIGS. 1 to 7 are therefore tool spindles for use in machine tools, in particular such as gear grinding machines.

FIG. 1 shows a perspective view of an inventive spindle unit of a machine tool having a housing 1 and a spindle shaft 2 rotatably supported therein. A grinding tool 4 is attached to the spindle shaft 2 in the region of its first end. The grinding tool 4 can be in particular a worm grinding wheel such as that used for grinding gears.

FIGS. 2 and 3 each illustrate, in a schematic sectional central view, one of several possible characteristic bending behaviors of the spindle shaft 2 which, in the gear grinding machine shown by way of example in FIG. 2, is only mounted in the first bearing portion B at the two bearing points 13 and 14 and, in the gear grinding machine shown by way of example in FIG. 3, has an additional bearing at a third bearing point 15. For illustrative purposes, some elements of the spindle unit are omitted in each case in FIGS. 2 and 3, for example the housing and the drive unit. Likewise for illustrative purposes, the bending behavior of the spindle shaft 2 in FIGS. 1 and 2 is shown greatly exaggerated in each case. This bending behavior has also been illustrated schematically. It is known to the person skilled in the art that the bending behavior can vary very greatly depending on the rotational speed or rotational frequency.

The spindle shafts 2 shown in FIGS. 2 and 3 each have a mounting portion A on which a mounting device in the form of a grinding tool flange 3 with a grinding tool 4 attached thereto is arranged. In FIGS. 2 to 7, the grinding tool 4 is mounted on the spindle shaft 2, in each case by way of example, by means of a grinding tool flange 3. It is also conceivable to mount the grinding tool 4 on the spindle shaft 2 directly (without a grinding tool flange 3). The cylindrically illustrated grinding tool 4 (or the truing tool and/or the workpiece, respectively) can furthermore also be disk shaped. In a force-transfer portion C, the spindle shaft 2 is set in rotation about the axis of rotation RA by means of a drive unit not shown here. Between the mounting portion A and the force-transfer portion C, the spindle shafts 2 shown in the FIGS. 2 and 3 each have a first bearing portion B having the two bearing points 13 and 14. The third bearing point 15, which is additionally provided in the case of the spindle shaft 2 shown in FIG. 3, is arranged in a second bearing portion D on the side of the force-transfer portion C which is opposite the first bearing portion B. The first and second bearing points 13 and 14 are each formed by a conically formed axial radial bearing; the third bearing point 15 by a cylindrical radial bearing.

At high rotational speeds of the spindle shaft 2 about the axis of rotation RA, the spindle shaft 2 tends, for various reasons, to vibrate and, accordingly, to bend. The longitudinal center line of the spindle shaft 2, which normally coincides with the axis of rotation RA in the idle state, then bends away from the axis of rotation RA in certain regions in the radial direction, as illustrated by the bending line BL in FIGS. 2 and 3.

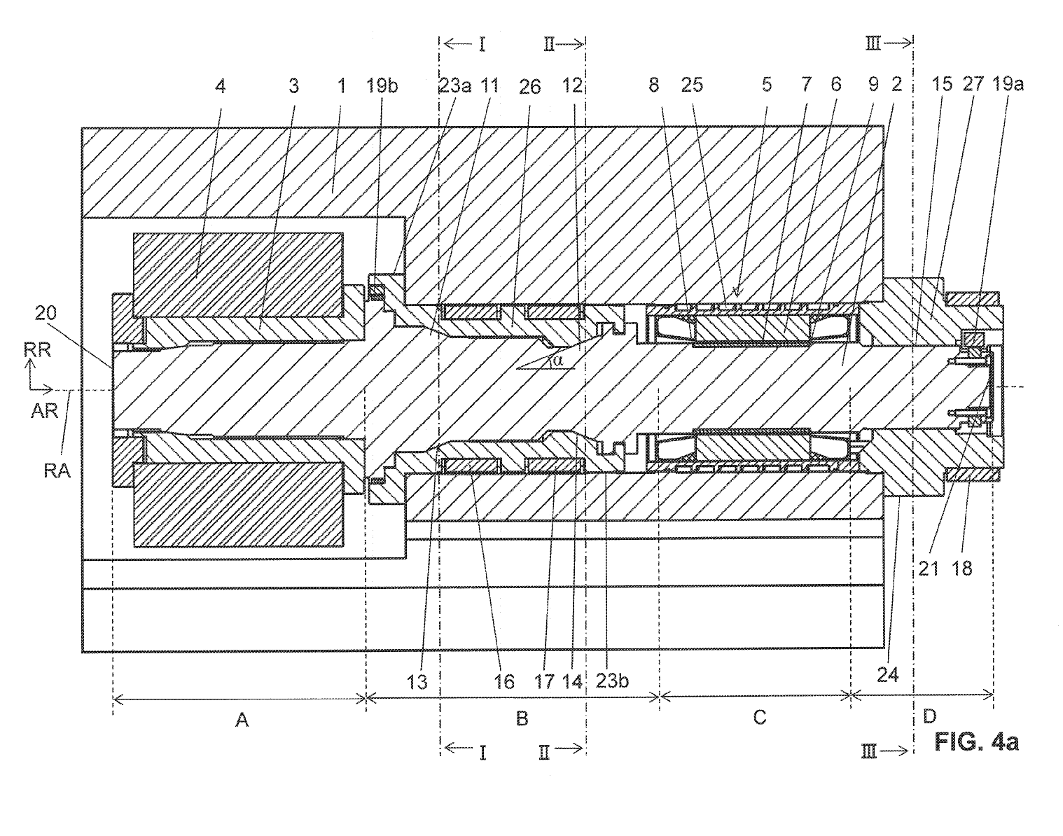

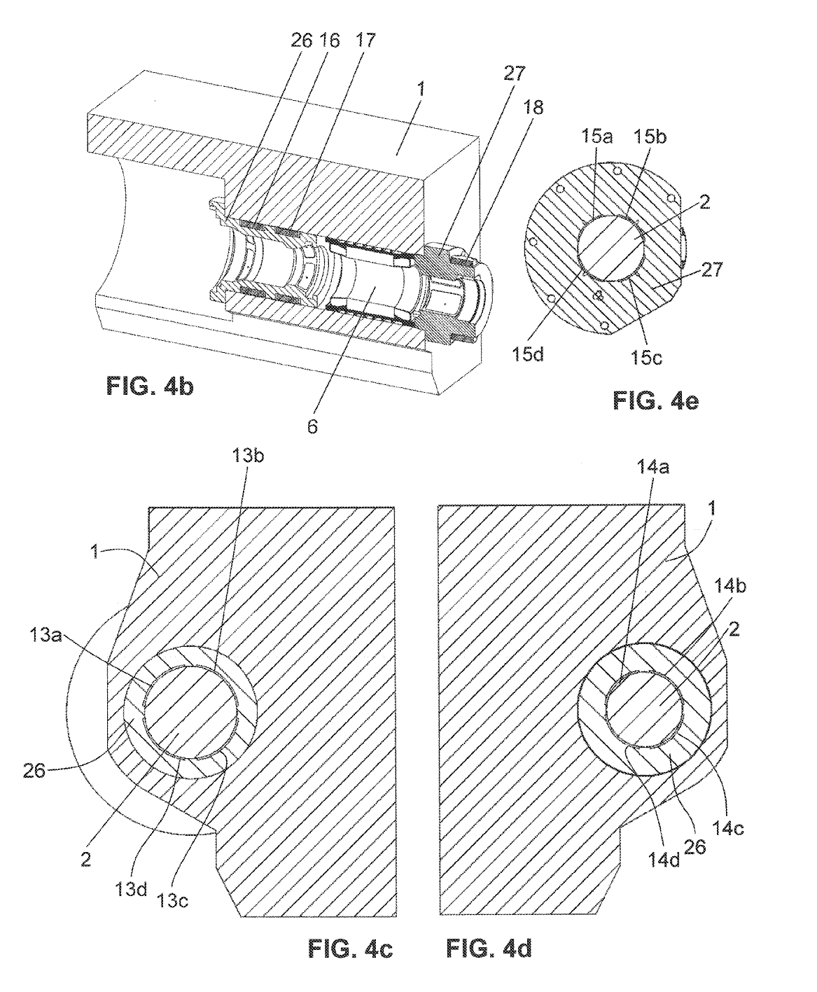

In the non-inventive spindle unit of a machine tool, which is shown in FIG. 2, the spindle shaft 2 is only supported in the first bearing portion B at the two bearing points 13 and 14. In this case, the spindle shaft 2 bends strongly away from the axis of rotation RA with its longitudinal center line in each case in its end regions, i.e. in the region of the first spindle end 20 and in the region of the second spindle end 21. The bending-away of a region of the spindle shaft 2 from the axis of rotation RA becomes stronger the further away the region is from the next bearing point 13 or 14. The vibrating behavior of the spindle shaft 2 is therefore most pronounced in the regions of the first and second spindle end 20 and 21. This is unfavorable precisely because the first spindle end 20 is formed by the mounting portion A to which the grinding tool 4 is attached. The relatively strong vibrations of the first spindle end 20 are thus transferred directly to the grinding tool 4 and therefore impair the surface quality of the workpiece. The spindle end 21 on which, in most embodiments, an angle measuring device 19a (see FIG. 4a) is arranged behaves in the same way or, at certain frequencies/speeds, even more pronouncedly. The relatively strong vibrations also influence the grinding result since measuring errors can occur here.

With an additional radial bearing of the spindle shaft 2 in the second bearing portion D, as shown in FIG. 3, vibrations are prevented not only in the region of the second bearing portion D itself, which is of great significance for the angle measuring device 19a, but also in the mounting portion A. At high rotational speeds, the spindle shaft 2 is therefore bent less strongly overall and in particular in the region of the mounting portion A as well as in the second bearing portion D. The substantially reduced vibrations of the mounting portion A and the bearing portion D result in an improved grinding quality.

FIGS. 4a to 4d show an inventive exemplary embodiment of a spindle unit of a gear grinding machine having a spindle shaft 2, which is divided successively along the axis of rotation RA into a mounting portion A, a first bearing portion B, a force-transfer portion C and a second bearing portion D. The individual portions A, B, C and D adjoin one another directly here, without overlapping one another.

The axis of rotation RA corresponds to the longitudinal center axis of the spindle shaft 2. With its axis of rotation RA, the spindle shaft 2 defines an axial direction AR corresponding to the axis of rotation RA and a host of radial directions RR at a right angle thereto.

A stator unit 6 is connected to the housing 1 in a torsion-resistant manner. The stator unit 6 is part of a drive unit 5 in the form of an electric motor, which serves to drive the spindle shaft 2 in a rotational movement about its axis of rotation RA. A rotor unit 7, which likewise forms part of the drive unit 5, is attached to the spindle shaft 2, directly adjacent to the stator unit 6, in a torsion-resistant manner. The rotor unit 7 is formed here by a plurality of permanent magnets which are attached circumferentially to the outside of the spindle shaft 2. Whilst the spindle shaft 2 is radially surrounded by the rotor unit 7, the stator unit 6 surrounds the rotor unit 7. The spindle shaft 2, the rotor unit 7 and the stator unit 6 are arranged concentrically to one another. A cooling channel 25, or a plurality of cooling channels, is provided in the radial direction between the stator unit 6 and the housing 1 for conducting a coolant in order to dissipate the thermal energy produced during operation of the drive unit 5.

The force-transfer portion C of the spindle shaft 2 is defined by the arrangement of the drive unit 5 and in particular of the rotor unit 7 along the axis of rotation RA and extends in the axial direction AR at least from a first end 8 of the rotor unit 7 to a second end 9 of the rotor unit 7. During operation of the spindle unit, a drive force is transferred along the force-transfer portion C from the drive unit 5 to the spindle shaft 2, whereby the spindle shaft 2 is set in rotation about its axis of rotation RA.

In the region of the first spindle end 20, a grinding tool flange 3, which serves as a mounting device for the torsion-resistant attachment of a grinding tool 4, is attached to the mounting portion A of the spindle shaft 2. When the grinding tool 4 is mounted on the grinding tool flange 3, the spindle shaft 2 projects in the axial direction AR into or through a bore in the grinding tool 4. It is equally conceivable to mount a grinding tool in such a way that the spindle end does not project or only partly projects therethrough.

A first angle measuring device 19a for detecting the respective angular position of the spindle shaft 2 about its axis of rotation RA is provided by way of example at the second spindle end 21. A second angle measuring device 19b is likewise arranged by way of example on the first bearing portion B, directly adjacent to the mounting portion A, on the spindle shaft. With the aid of the angle measuring devices 19a and/or 19b, it is possible to ensure that the rotational speed of the spindle shaft 2 and therefore the grinding tool 4 corresponds as precisely as possible to the value specified by the control of the machine during the grinding procedure. The angle measuring devices can also be arranged at another point along the spindle axis, for example in the transition region from the first bearing portion B to the force-transfer portion C, and/or the arrangement of only one angle measuring device is also possible.

The spindle shaft 2 has a first, a second and a third bearing point 13, 14, 15 along the axial direction AR. The first bearing point 13 and the second bearing point 14 are each provided on a first fixed sleeve 26, which is attached to the housing 1 in a torsion-resistant manner. The third bearing point 15 is arranged on a second fixed sleeve 27, which is likewise attached to the housing 1 in a torsion-resistant manner.

The first bearing point 13 and the second bearing point 14 are arranged at a spacing from one another in the axial direction AR on the first bearing portion B, which extends between the grinding tool flange 3 and the rotor unit 7. To enable high rotational speeds and moreover to optimally damp possibly occurring vibrations, both the first bearing point 13 and the second bearing point 14 are each formed by a hydrostatic bearing. The bearings of the bearing points 13 and 14 are each conically formed and have a plurality (by way of example, 4 bearing pockets are illustrated in each case) of bearing pockets 13a, 13b, 13c, 13d, or 14a, 14b, 14c, 14d, respectively, (see FIGS. 4c and 4d) arranged at regular spacings about the spindle axis 2. In the axial direction AR, the bearing pockets 13a, 13b, 13c, 13d, or 14a, 14b, 14c, 14d, respectively, of the bearing points 13 and 14 are each sealed to the outside on both sides by means of sealing-air arrangements. Return channels for the fluid are generally located by way of example on both sides in the axial direction AR between the bearing points and the sealing-air arrangements.

The conical form of the first bearing point 13 and the second bearing point 14 determines that these are each arranged in a region of the spindle shaft 2 which tapers conically or widens conically, respectively, along the axial direction AR. In the present embodiment, the bearing of the first bearing point 13 tapers along the axial direction AR extending from the first spindle end 20 to the second spindle end 21. The bearing of the second bearing point 14, on the other hand, widens conically in the direction from the first spindle end 20 to the second spindle end 21. The cones formed by the bearings of the first and the second bearing point 13, 14 are therefore aligned with their opening angles α along the axial direction AR in mutually opposite directions. The opening angles α (see FIG. 4) of the bearings of the first and the second bearing point 13, 14, which are measured relative to the axis of rotation RA, are preferably each between 10° and 60°. Owing to their conical design, the bearings of the bearing points 13 and 14 are each formed for absorbing forces acting both in the radial direction RR and in the axial direction AR.

The third bearing point 15 is formed by a cylindrical radial bearing, which is arranged on the second bearing portion D of the spindle shaft 2. The second bearing portion D extends in the axial direction AR from the force-transfer portion C to the second spindle end 21.

The bearing of the third bearing point 15 serves to stabilize the second spindle end 21 of the spindle shaft 2 in the radial direction RR. On the one hand, it is thus prevented that radial vibrations amplify in the region of the mounting device and thus impair the rotation of the grinding tool 4 and therefore the grinding quality. On the other hand, the bearing of the third bearing point 15 reduces measuring errors which occur as a consequence of the spindle bending at the second spindle end 21 and therefore near the angle measuring device 19a. During operation of the gear grinding machine, such measuring errors can lead to asynchronous rotational movements of the grinding tool 4 and the workpiece to be ground and therefore to an impaired grinding quality.

To enable relatively high rotational speeds of 3000 or even more revolutions per minute, the third bearing point 15 is also formed by a hydrostatic bearing. This has a plurality (by way of example, 4 bearing pockets are also illustrated here) of bearing pockets 15a, 15b, 15c, 15d, which are arranged at regular spacings about the spindle shaft 2 (see FIG. 4e), which is formed correspondingly cylindrically in the region of the third bearing 15. The bearing pockets 15a, 15b, 15c, 15d of the third bearing point 15 are also each sealed to the outside on both sides in the axial direction AR by means of sealing-air arrangements. Return channels for the fluid are generally located by way of example on both sides in the axial direction AR between the bearing points and the sealing-air arrangements. Instead of being formed by a hydrostatic bearing, the third bearing point 15 can also be formed by a hydrodynamic bearing.

The third bearing point 15 here is formed and arranged on the spindle shaft 2 in particular in such a way that movements of the spindle shaft 2 along the axial direction AR through the bearing of the third bearing point 15 are possible to a certain extent. Linear expansions of the spindle shaft 2, which are caused by a heating of the spindle shaft 2 during operation of the gear grinding machine, thus have no effect on the spindle bearing in the third bearing point 15. Although a temperature-related linear variation in the spindle shaft 2 results in a certain displacement of the spindle shaft 2 along the axial direction AR in the region of its second bearing portion D, it only results in a minimum displacement of the mounting portion A, and in particular the grinding tool 4, as a result of the first bearing point 13 and the second bearing point 14 moreover being arranged very close to one another and near to the grinding tool 4.

A plurality of first pressure controllers 16 are provided for controlling the hydrostatic pressure in the bearing of the first bearing point 13. Since, in each case, one of these first pressure controllers 16 is associated with, and connected to, each of the bearing pockets 13a, 13b, 13c, 13d belonging to the bearing of the first bearing point 13, the number of first pressure controllers 16 corresponds to the number of bearing pockets 13a, 13b, 13c, 13d belonging to the bearing of the bearing point 13. The same applies to the plurality of second pressure controllers 17 and the plurality of third pressure controllers 18, which serve for controlling the pressure conditions in the bearing pockets 14a, 14b, 14c, 14d, or 15a, 15b, 15c, 15d, respectively, of the bearings belonging to the second or third bearing point 14 or 15 respectively. In each case, one of the second pressure controllers 17 here is also associated with each of the bearing pockets 14a, 14b, 14c, 14d of the second bearing point 14 and in each case one of the third pressure controllers 18 is associated with each of the bearing pockets 15a, 15b, 15c, 15d of the third bearing point 15.

The first, second and third pressure controller 16, 17 and 18 each have a compact construction so that they can be accommodated in a housing which is closed to the outside. Each of the plurality of first, second and third pressure controllers 16, 17 and 18 is connected in each case via one pressure line to the correspondingly associated bearing pocket 13a, 13b, 13c, 13d, or 14a, 14b, 14c, 14d, or 15a, 15b, 15c, 15d, respectively, of the first, second or third bearing point 13, 14, and 15, respectively.

The first, second and third pressure controller 16, 17 and 18 are preferably each based exclusively on mechanical components, for example spring elements, and on hydraulic components, for example throttles. The pressure in the pressure- or bearing pockets 13a, 13b, 13c, 13d, or 14a, 14b, 14c, 14d, or 15a, 15b, 15c, 15d, respectively, can thus be controlled without electrical energy, which also dispenses with the need for corresponding wiring. The pressure controllers 16, 17 and 18 are advantageously formed according to one of the exemplary embodiments disclosed in EP 0 840 190 B1.

The plurality of first, second and third pressure controllers 16, 17 and 18 are each attached directly to a component of the spindle unit, which, in the radial direction RR, is arranged directly adjacent to that spindle shaft portion on which the bearing pocket 13a, 13b, 13c, 13d, or 14a, 14b, 14c, 14d, or 15a, 15b, 15c, 15d, respectively, connected to this pressure controller is located. The pressure controllers 16, 17 and 18 are each arranged approximately at the height of the corresponding bearing point 13, 14 or 15, respectively, along the axial direction AR. In the embodiment shown in FIGS. 4a-4e, the first pressure controllers 16 and the second pressure controllers 17 are each arranged at the first bearing portion B and, in particular, between the first bearing point 13 and the second bearing point 14 in the axial direction AR. The third pressure controllers 18, of which two can also be seen in FIG. 1, are located at the second bearing portion D.

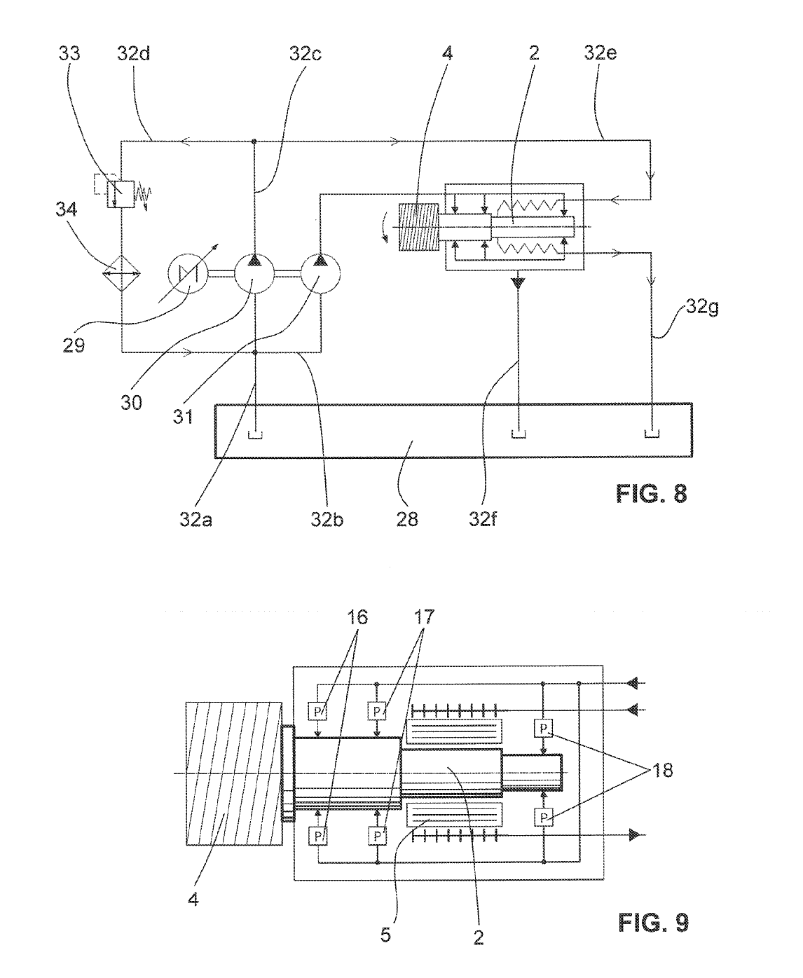

The plurality of pressure controllers 16, 17 and 18 in each case and the individual bearing pockets 13a, 13b, 13c, 13d, or 14a, 14b, 14c, 14d, or 15a, 15b, 15c, 15d, respectively, of the first, second and third bearing point 13, 14 and 15 are connected to one another by means of a common fluid circuit, which cannot be seen in FIG. 4a but is shown in FIGS. 8 and 9 and described further below. A fluid circulates in the fluid circuit, which serves not only for controlling the pressure ratios prevailing in the individual bearing pockets but also for cooling and lubricating the first, second and third bearing point 13, 14 and 15. The same fluid can moreover be used for cooling the drive unit 5.

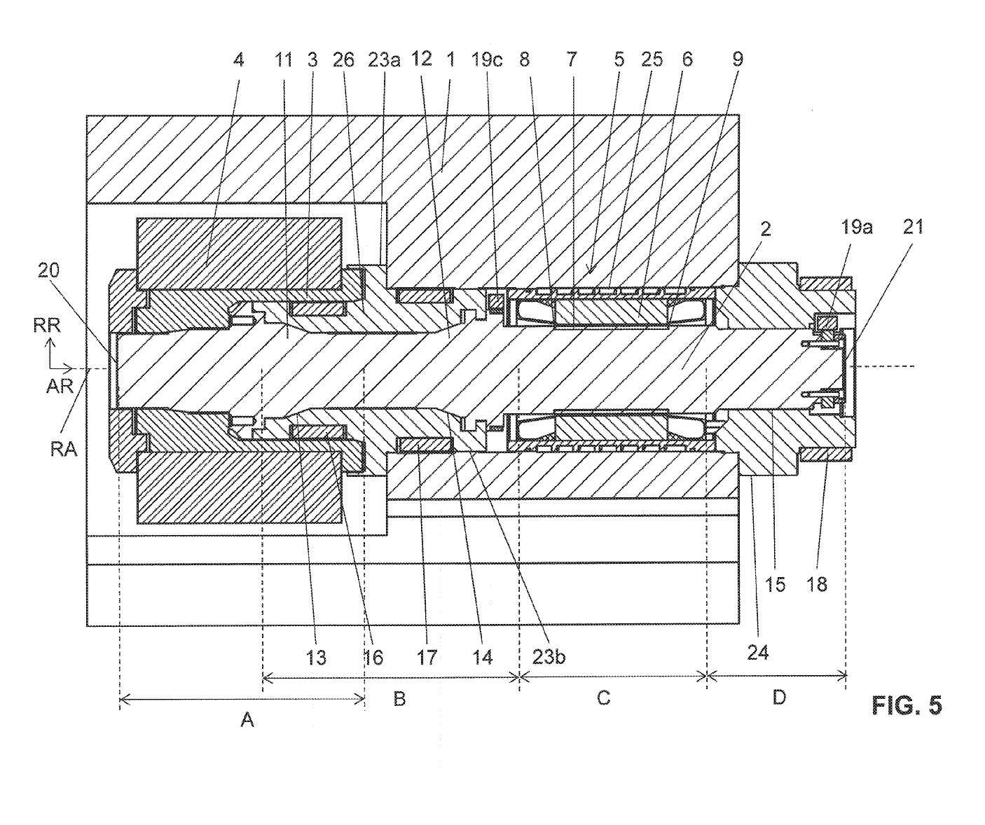

A further embodiment of an inventive spindle unit, which is illustrated by way of example on a gear grinding machine, is shown in FIG. 5. This embodiment of FIG. 5 corresponds substantially to the embodiment of FIG. 4, the difference being that the first bearing point 13 here is arranged at the same height as the grinding tool flange 3 along the axial direction AR and, if a grinding tool 4 is attached to said grinding tool flange, also at the same height as this grinding tool 4. The mounting portion A and the first bearing portion B therefore partly overlap here in the axial direction AR. Along the radial direction RR, the first bearing point 13 in the second embodiment is arranged here within the grinding tool flange 3 so that, if a grinding tool 4 is attached to the grinding tool flange 3, it is radially surrounded by this. The first pressure controllers 16 here are also arranged at the same point as the grinding tool flange 3 in the axial direction AR and therefore in the mounting portion A. If a cylindrical grinding tool 4 is attached to the grinding tool flange 3, the first pressure controllers 16, like the first bearing point 13, are located within the bore of the grinding tool 4. As in the embodiment of FIG. 4, the second bearing point 14 is arranged between the grinding tool flange 3 and the first rotor end 8 in the axial direction AR.

Since the first bearing point 13 is located within the mounting portion A and therefore directly in the region of the grinding tool flange 3, vibrations of the grinding tool 4 are optimally damped. Moreover, the spindle shaft 2 can thus have a smaller overall length and/or the spacing between the two bearings 13 and 14 can be increased.

The embodiment illustrated in FIG. 5 is suitable for grinding tools 4 from a certain bore diameter. However, the embodiment illustrated in FIGS. 4a-4e is more suitable for grinding tools 4 whereof the bore diameter is relatively small, since the first bearing point 13 and the first pressure controllers 16 there do not have to be accommodated within the bore of the grinding tool 4 but are arranged outside this. The embodiment of FIG. 4 is therefore particularly suitable for grinding tools which are formed for grinding at a very high circumferential speed and therefore have a large radial wall thickness.

In contrast to the embodiment shown in FIGS. 4a-4e, in the embodiment of FIG. 5 the second angle measuring device 19c is arranged by way of example directly adjoining the force-transfer portion C on the first bearing portion B.

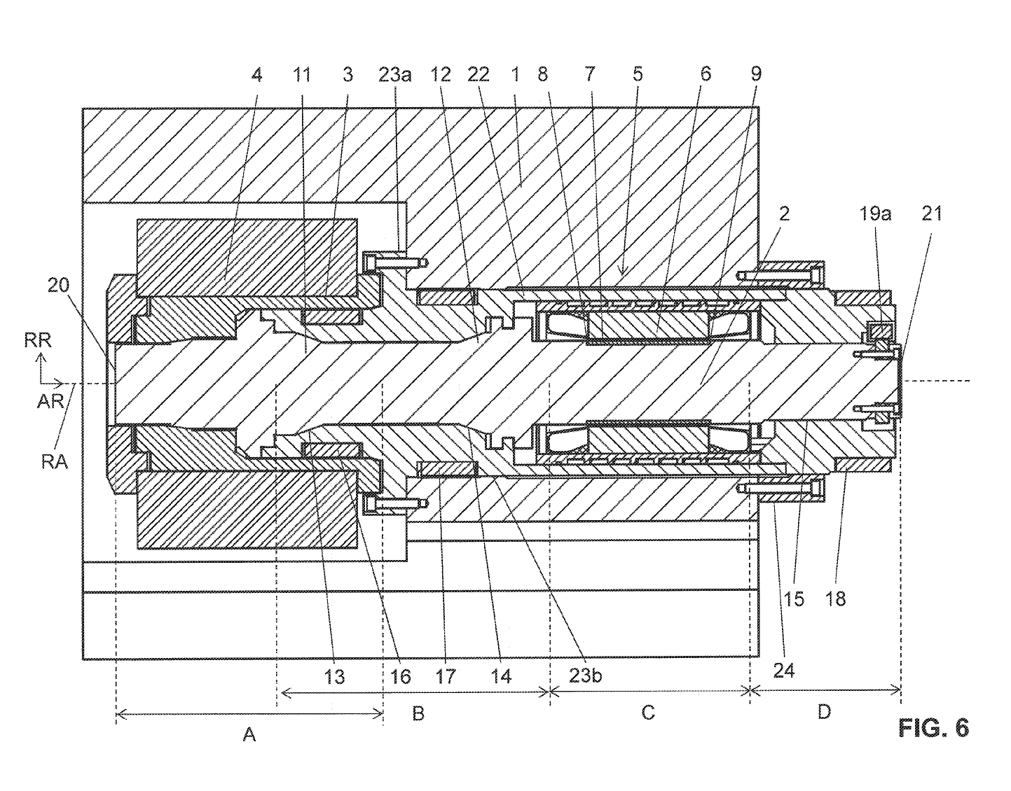

A further embodiment of an inventive spindle unit of a gear grinding machine is shown in FIG. 6. This embodiment corresponds substantially to that of FIG. 5, although it could also be configured as in FIGS. 4a-4e, with the exception that an insert sleeve 22 is provided here, in which the spindle shaft 2 and the drive unit 5 are accommodated. A first sleeve support 23a serves for mounting the insert sleeve 22 in a receiving region provided accordingly on the housing 1. By way of example, the sleeve support 23a is a screw connection which is formed and arranged in such a way that both axial and also radial forces are transferred from the insert sleeve 22 to the housing 1 and can be absorbed by this latter. Along the axial direction AR, further sleeve supports are conceivable, which are preferably each located at the same height as the bearing points 14 and 15 and are formed such that the radial forces can be transferred to the housing 1. The sleeve supports 23b and 24 are illustrated by way of example in FIG. 6. The insert sleeve 22 has an external diameter which is approximately the same size as the internal diameter of the corresponding receiving region of the housing 1. The sleeve support 24 can be formed as a separate component, which is connected to the housing 1 by means of a screw connection for example, or it can be formed in one piece from the housing 1.

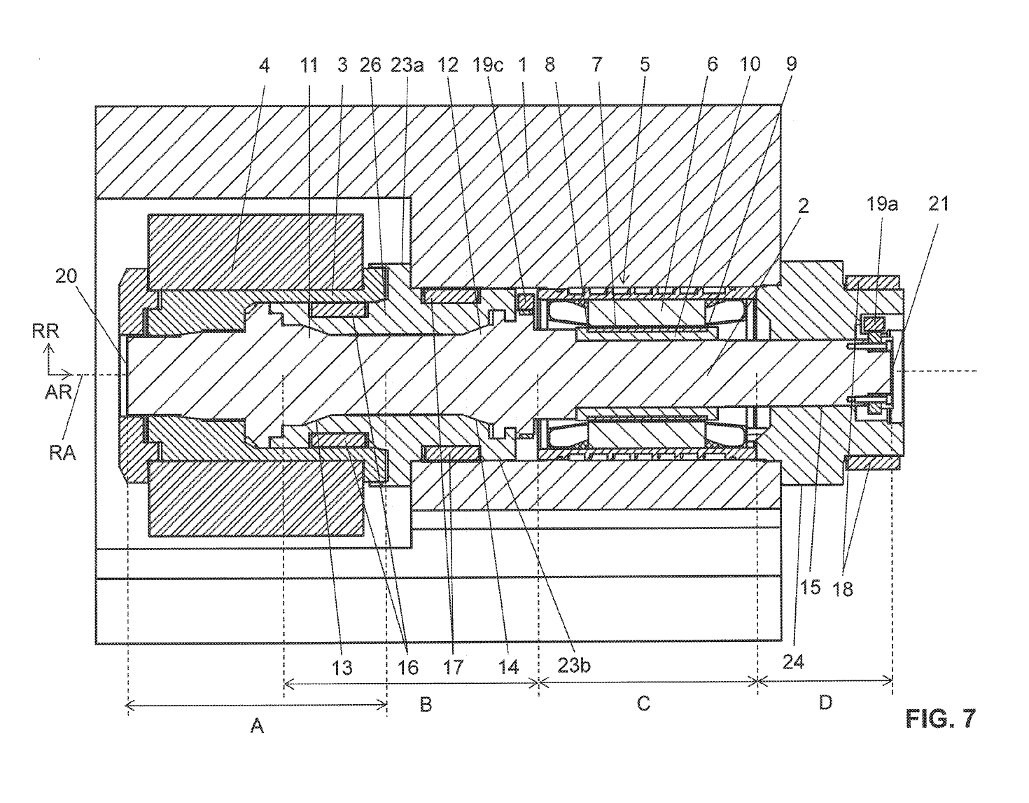

The inventive embodiment shown in FIG. 7 differs from that of FIGS. 4a-4e and also from that of FIGS. 5 and 6 in that the rotor unit 7 here is fixed on the outside of a holding sleeve 10, which is pushed onto the spindle shaft 2 and mounted thereon in a torsion-resistant manner. The rotor unit 7 can thus be attached to, or removed from, respectively, the spindle shaft very easily during assembly or for maintenance purposes, respectively. To enable the attachment of the holding sleeve 10, however, the external diameter of the spindle shaft 2 in the force-transfer portion C and in the second bearing portion D is somewhat smaller than that of the spindle shaft 2 shown in FIG. 4a.

An exemplary diagram of a fluid circuit for lubricating or supporting and cooling the bearing points 13, 14, 15 and for cooling the drive unit 5 is shown in FIGS. 8 and 9. The diagram shown in FIGS. 8 and 9 can be used in all embodiments according to FIGS. 1 to 7.

A common fluid reservoir 28, which serves for receiving the fluid, is integrated in the fluid circuit. The fluid received in the fluid reservoir 28 is used both for the hydrostatic bearing 13, 14 and 15 as a whole and for cooling the drive unit 5, which serves for driving the spindle shaft 2.

The fluid can be taken into a first fluid line 32a from the fluid reservoir 28 by means of a first and a second fluid pump 30 and 31, which are driven together by a drive motor or separately by a plurality (not illustrated) of drive motors 29. The first fluid line 32a branches into a second fluid line 32b and a third fluid line 32c.

The second fluid pump 31, which supplies the fluid under pressure to the first, second and third pressure controllers 16, 17, 18 in order to lubricate and cool them, is arranged within the second fluid line 32b. The first, second and third pressure controllers 16, 17 and 18 here are arranged parallel to one another in the fluid circuit.

The third fluid line 32c, within which the first fluid pump 30 is arranged, branches into a fourth fluid line 32d and a fifth fluid line 32e. The fourth fluid line 32d leads back to the branching point, where the first fluid line 32a leads into the second and the third fluid line 32b and 32c. The fourth fluid line 32d serves for the cooling and filtration of the fluid. A pre-tension valve 33 and a heat exchanger 34 are arranged in succession within the fourth fluid line 32d. The fluid arrives via the fifth fluid line 32e at the drive unit 5, through which fluid therefore flows parallel in relation to the pressure controllers 16, 17 and 18 for cooling purposes. From the pressure controllers 16, 17 and 18, the fluid arrives back in the fluid reservoir 28 via a sixth fluid line 32f.

Parallel thereto, the fluid arrives back in the fluid reservoir 28 from the drive unit 5 via a seventh fluid line 32g.

The exemplary fluid diagram for lubricating or supporting and cooling, respectively, the bearing points 13, 14, 15 and cooling the drive unit 5 shows a fluid circuit. This supply and return of the fluid is not illustrated in FIGS. 1 to 7.

This diagram of a fluid circuit for lubricating or supporting and cooling, respectively, the bearing points 13, 14, 15 and cooling the drive unit 5 merely represents a possible arrangement. It is for example also conceivable to configure the lubricating or supporting process and cooling process, respectively, of the bearing points 13, 14, 15 completely independently of the cooling process of the drive unit 5; the individual bearing points 13, 14, 15 could also be supplied with the fluid independently of one another. It is likewise conceivable that different fluids for cooling the drive unit 5 and the bearing points 13, 14, 15 are used, for example.

It goes without saying that the invention described here is not restricted to the embodiments mentioned and a plurality of modifications is possible. Therefore, instead of a grinding tool flange 3, the spindle shaft 2 can also have, for example, a mounting device for attaching a workpiece to be ground. The spindle shaft 2 would then not be a tool spindle but a workpiece spindle. These statements also apply analogously to a truing spindle. The drive unit does not necessarily have to be an electric motor with a stator unit surrounding the spindle shaft 2 and a rotor unit attached to the spindle shaft 2. Instead, other desirable drives from the prior art are conceivable, for example a belt drive or the like. The first bearing point 13 and/or the second bearing point 14 do not necessarily have to be conically formed, but could be formed from a hydrostatic radial bearing and a hydrostatic axial bearing in each case. A plurality of further modifications is conceivable.

### LIST OF REFERENCE SIGNS

1 Housing
2 Spindle shaft
3 Grinding tool flange
4 Grinding tool
5 Drive unit
6 Stator unit
7 Rotor unit
8 First end of the rotor unit
9 Second end of the rotor unit
10 Holding sleeve
11 First conical region
12 Second conical region
13 First bearing point
13a,b,c,d Bearing pocket
14 Second bearing point
14a,b,c,d Bearing pocket
15 Third bearing point
15a,b,c,d Bearing pocket
16 First pressure controller
17 Second pressure controller
18 Third pressure controller
19a,b,c Angle measuring device
20 First spindle end
21 Second spindle end
22 Insert sleeve
23a First sleeve support
23b Second sleeve support
24 Third sleeve support
25 Cooling channel
26 First fixed sleeve
27 Second fixed sleeve
28 Fluid reservoir
29 Drive motor
30 First fluid pump
31 Second fluid pump
32a-g Fluid lines
33 Pre-tension valve
34 Heat exchanger
A Mounting portion
B First bearing portion
C Force-transfer portion
D Second bearing portion
RA Axis of rotation
AR Axial direction
RR Radial direction
BL Bending line
α Opening angle

1. A spindle unit for a machine tool for fine-machining workpieces having groove-shaped profiles, comprising:
a spindle shaft which is mounted to be rotatable about an axis of rotation and defines an axial direction and a radial direction with this axis of rotation, and which is divided successively in the axial direction into a mounting portion for attaching a tool or a workpiece to be machined, a first bearing portion, a force-transfer portion and a second bearing portion;
a drive unit for driving the spindle shaft in a rotational movement about the axis of rotation by means of force transfer to the force-transfer portion;
a first bearing point and a second bearing point for supporting the spindle shaft in the first bearing portion and
a third bearing point for supporting the spindle shaft in the second bearing portion,
wherein
the first and the second bearing point each have one or more hydrostatic bearings and are each formed for absorbing both radial and axial forces, and wherein the third bearing point has one or more hydrostatic and/or hydrodynamic bearings and is formed for absorbing radial forces.

2. The spindle unit as claimed in claim 1, wherein the first and/or the second bearing point is conically formed.

3. The spindle unit as claimed in claim 2, wherein both the first and the second bearing point are conically formed and wherein the cones formed by these two bearing points are aligned in mutually opposite directions in relation to the axis of rotation.

4. The spindle unit as claimed in claim 2, wherein the cones formed by the first and/or by the second bearing point have an opening angle in a range of 10° to 60° in relation to the axis of rotation.

5. The spindle unit as claimed in claim 1, wherein the third bearing point is additionally formed for absorbing axial forces.

6. The spindle unit as claimed in claim 1, wherein the first bearing point has one or more first bearing pockets and the second bearing point has one or more second bearing pockets and wherein at least one first pressure controller is provided, which serves for controlling the pressure conditions prevailing in the first bearing pockets, and at least one second pressure controller is moreover provided, which serves for controlling the pressure conditions prevailing in the second bearing pockets and is formed separately in relation to the first pressure controller(s).

7. The spindle unit as claimed in claim 6, wherein a plurality of first bearing pockets and a plurality of second bearing pockets as well as a plurality of first pressure controllers and a plurality of second pressure controllers are present and wherein each of the first bearing pockets is associated with one of the first pressure controllers in each case and each of the second bearing pockets is associated with one of the second pressure controllers in each case.

8. The spindle unit as claimed in claim 6, wherein the third bearing point has a hydrostatic bearing having one or more third bearing pockets and wherein at least one third pressure controller is provided, which serves for controlling the pressure conditions prevailing in the third bearing pockets and is formed separately in relation to the first pressure controller(s) and the second pressure controller(s).

9. The spindle unit as claimed in claim 8, wherein a plurality of third bearing pockets as well as a plurality of third pressure controllers are present and wherein each of the third bearing pockets is associated with one of the third pressure controllers in each case.

10. The spindle unit as claimed in claim 6, wherein the first pressure controller(s) and the second pressure controller(s) are each formed as progressive flow controllers.

11. The spindle unit as claimed in claim 6, wherein the first pressure controller(s), and the second pressure controller(s) each have a compact construction and wherein the corresponding pressure controls take place by means of capillaries and/or throttles and/or restrictors and/or by means of an electronic control.

12. The spindle unit as claimed in claim 6, wherein the first pressure controller(s) are each arranged substantially at the same height as the first bearing point relative to the axial direction, and wherein the second pressure controller(s) are each arranged at substantially the same height as the second bearing point relative to the axial direction.

13. The spindle unit as claimed in claim 6, wherein a mounting device is attached to the mounting portion of the spindle shaft for attaching a tool or a workpiece to be machined and wherein the first pressure controller(s) are arranged in the region of the mounting device along the axial direction.

14. The spindle unit as claimed in claim 1, wherein one or more fluid circuits are provided, which serve both for lubricating and also for cooling the first and the second bearing point.

15. The spindle unit as claimed in claim 1, additionally having at least one angle measuring device for detecting the rotational speed of the spindle shaft.

16. The spindle unit as claimed in claim 1, wherein sealing-air arrangements are provided to seal the bearing pockets of the first and the second bearing point, to the outside in the axial direction.

17. A machine tool having a spindle unit for fine-machining workpieces having groove-shaped profiles, the spindle unit comprising:
a spindle shaft which is mounted to be rotatable about an axis of rotation and defines an axial direction and a radial direction with this axis of rotation, and which is divided successively in the axial direction into a mounting portion for attaching a tool or a workpiece to be machined, a first bearing portion, a force-transfer portion and a second bearing portion;
a drive unit for driving the spindle shaft in a rotational movement about the axis of rotation by means of force transfer to the force-transfer portion;
a first bearing point and a second bearing point for supporting the spindle shaft in the first bearing portion and
a third bearing point for supporting the spindle shaft in the second bearing portion,
wherein
the first and the second bearing point each have one or more hydrostatic bearings and are each formed for absorbing both radial and axial forces, and wherein the third bearing point has one or more hydrostatic and/or hydrodynamic bearings and is formed for absorbing radial forces.

18. The spindle unit as claimed in claim 10, wherein the progressive flow controllers each have exclusively mechanical and/or hydraulic elements.

19. The spindle unit as claimed in claim 13, wherein the first pressure controller(s) are arranged within the mounting device in the radial direction.

20. The spindle unit as claimed in claim 14, wherein the one or more fluid circuits serve also for cooling the drive unit.

21. The spindle unit as claimed in claim 16, wherein the sealing-air arrangements are provided also to seal the bearing pockets of the third bearing point, to the outside in the axial direction.
